(19) United States
(12) Patent Application Publication
(10) Pub. No.: US 2009/0193660 A1
(43) Pub. Date: Aug. 6, 2009

(54) Adjustable cake cutter

(76) Inventors: Jia Sheng Chen, Miaoli (TW); Zhen Yi Wang, Taichung (TW); Yu Chun Kao, Taichung (TW)

Correspondence Address: CHARLES E. BAXLEY, ESQUIRE, 90 JOHN STREET, SUITE 309, NEW YORK, NY, 10038, US

(21) Appl. No.: 12/012,717

(22) Filed: Feb. 5, 2008

(51) Int. Cl. A21C 15/04; A21C 15/00; B26B 1/00

(52) U.S. Cl. 30/114; 30/298; 30/320

(57) ABSTRACT

A cake cutter includes a cutter blade having a female engaging member, and another cutter blade having a male engaging member for engaging with the female engaging member and for allowing the cutter blades to be quickly and pivotally coupled together and to be easily and quickly detached from each other. One of the cutter blades includes an arm, and a ramp extended from the arm, and the other cutter blade includes one or more projections for slidably engaging with the ramp of the arm and for adjustably coupling the cutter blades together and for allowing the cutter blades to be easily and readily and detachably adjusted relative to each other for cutting a piece of cake into any selected dimensions or widths.

### BACKGROUND OF THE INVENTION

1. Field of the Invention

The present invention relates to a cake cutter, and more particularly to an adjustable cake cutter including two cutter blades easily and readily and detachably coupled together and adjustable relative to each other for cutting a piece of cake into selected or required dimensions or widths.

2. Description of the Prior Art

Typical cake cutters comprise a V-shaped cutting blade with two longitudinal cutting sides and a curved apex formed between the cutting sides, and the cutting blade is attached to an adjustable mechanism for adjusting the longitudinal cutting sides of the cutting blade relative to each other for cutting the cake into selected or required dimensions or widths.

For example, U.S. Pat. No. 4,553,325 to Allahverdian discloses one of the typical cake cutters comprising a cutting blade attached to a gear housing with rack and pinion means in conjunction with a plate to determine the length, and a helical screw in conjunction with the cutting blade to determine the width of a piece of cake to be cut, and securing means to secure the cut portion of the cake in position with the cutting blade.

However, the longitudinal cutting sides of the V-shaped cutting blade are integrally coupled together with the curved apex and may not be detached from each other such that the volume and the package space for the typical cake cutters are great and may not be suitably reduced.

U.S. Pat. No. 4,592,139 to Huang discloses another typical cake cutter comprising two flat cutting blades having one end pivotally coupled together with a plug-in pin and a screw, and having the other end movable or adjustable relative to each other for cutting a piece of cake into selected or required dimensions or widths.

However, it is time consuming to detach or disassemble the plug-in pin and the screw from the flat cutting blades.

U.S. Pat. No. 4,847,998 to Colozzi et al. discloses a further typical cake cutter comprising a vertical cutting blade with an outline of an isosceles triangle, and a handle affixed to each of two parts of the cutting blade, and the two legs of the handle being joined by an arcuate spring section.

However, the vertical and triangular cutting blade and the handle are integrally coupled and secured together and may not be detached from each other such that the volume and the package space for the typical cake cutters are great and may not be suitably reduced.

U.S. Design Pat. No. D446,690 to Meyer discloses a still further typical cake cutter comprising a V-shaped cutting blade with a curved apex and longitudinal cutting sides, and a handle integrally affixed to each of the longitudinal cutting sides of the typical cake cutters.

However, similarly, the longitudinal cutting sides of the V-shaped cutting blade are integrally coupled together with the curved apex and may not be detached from each other such that the volume and the package space for the typical cake cutters are great and may not be suitably reduced.

The present invention has arisen to mitigate and/or obviate the afore-described disadvantages of the conventional adjustable cake cutters.

### SUMMARY OF THE INVENTION

The primary objective of the present invention is to provide a cake cutter including two cutter blades easily and readily and detachably coupled together.

The other objective of the present invention is to provide a cake cutter including two cutter blades adjustable relative to each other for cutting a piece of cake into any selected or required dimensions or widths.

In accordance with one aspect of the invention, there is provided a cake cutter comprising a first cutter blade including a female engaging member provided on a first end portion of the first cutter blade, and a second cutter blade including a male engaging member provided on a first end portion of the second cutter blade for engaging with the female engaging member of the first cutter blade and for allowing the first end portions of the first and the second cutter blades to be pivotally coupled together and to be quickly detached from each other.

The female engaging member of the first cutter blade is a slot formed in the first end portion of the first cutter blade, and the male engaging member of the second cutter blade is a tongue extended from the first end portion of the second cutter blade for engaging with the female slot engaging member of the first cutter blade and for detachably coupling the first end portions of the first and the second cutter blades together.

The first cutter blade includes an arm extended from a second end portion of the first cutter blade, and includes a ramp extended from the arm, and the second cutter blade includes at least one projection extended from a second end portion of the second cutter blade for slidably engaging with the ramp of the first cutter blade and for adjustably coupling the second end portions of the first and the second cutter blades together.

The first cutter blade includes a handle extended from the arm. The second cutter blade includes a handle extended from the second end portion of the second cutter blade.

The second cutter blade includes a bar extended from the second end portion of the second cutter blade, and the projection is preferably extended from the bar. The handle may also be extended from the bar.

The second cutter blade includes a second projection extended from the second end portion of the second cutter blade for selectively and slidably engaging with the ramp of the first cutter blade and for allowing the second end portions of the cutter blades to be moved toward or away from each other or to be adjustable relative to each other to different width.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a cake cutter in accordance with the present invention;

FIG. 2 is an exploded view of the cake cutter;

FIG. 3 is a top plan schematic view of the cake cutter;

FIG. 4 is a top plan schematic view similar to FIG. 3, illustrating the operation of the cake cutter;

FIG. 5 is an enlarged partial top plan schematic view illustrating the operation of the cake cutter; and

FIG. 6 is an exploded view similar to FIG. 2, illustrating the other arrangement of the cake cutter.

### DETAILED DESCRIPTION OF THE PREFERRED EMBODIMENT

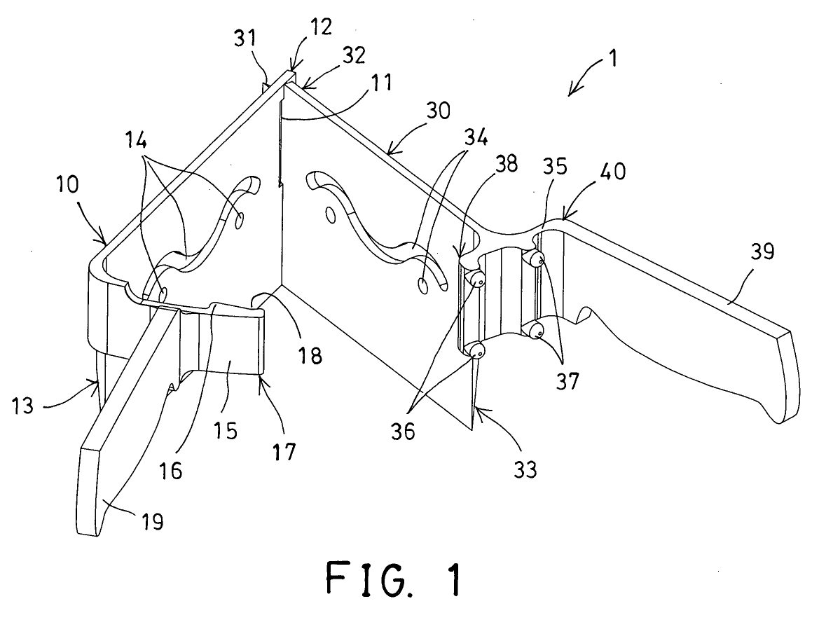

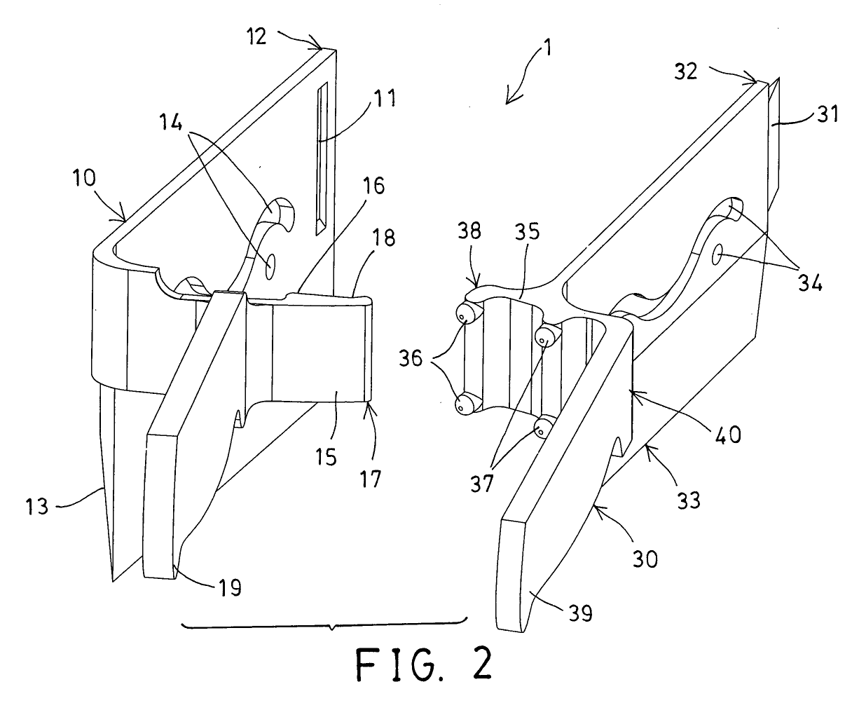

Referring to the drawings, and initially to FIGS. 1-3, a cake cutter 1 in accordance with the present invention comprises two cutter blades 10, 30 easily and readily and detachably coupled together and adjustable relative to each other for cutting a piece of cake into selected or required dimensions or widths. For example, one or first of the cutter blades 10 includes a female or first engaging member 11, such as a slot 11 provided or formed in one end portion 12 thereof, and the other or the second cutter blade 30 includes a male engaging member 31, such as a tongue 31 extended outwardly from one end portion 32 thereof for easily and readily and detachably engaging with or into the female slot engaging member 11 of the first cutter blade 10 and for allowing the one end portions 12, 32 of the cutter blades 10, 30 to be quickly and pivotally coupled together and to be easily and quickly detached from each other.

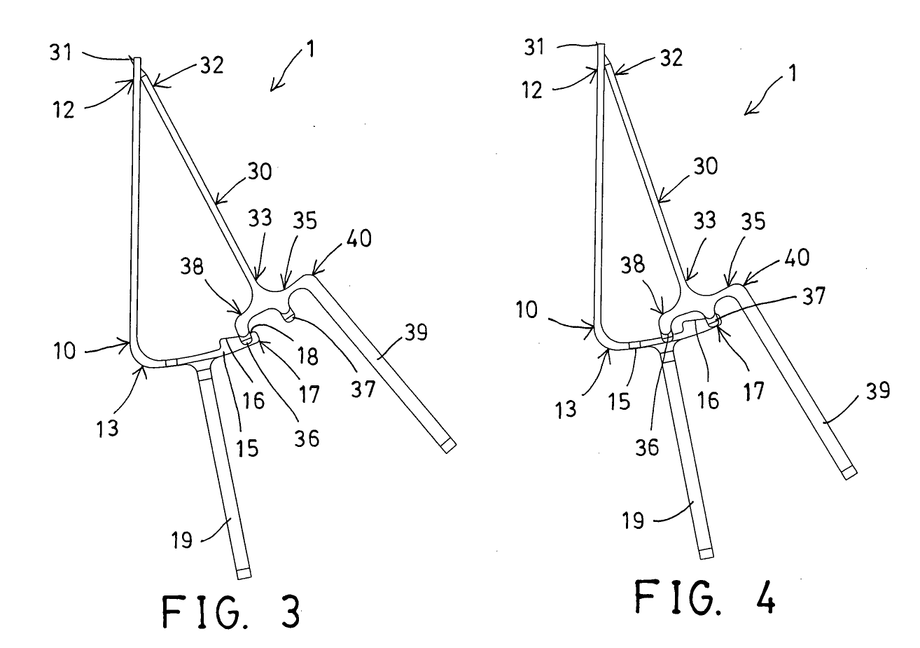

The cutter blades 10, 30 include the other end portions 13, 33 moveable relative to each other for allowing the other end portions 13, 33 of the cutter blades 10, 30 to be moved toward or away from each other or to be adjustable relative to each other to different width. The cutter blades 10, 30 each may include one or more openings 14, 34 formed therein for such as weight reducing purposes, and/or for decorative purposes. The first cutter blade 10 includes an arm 15 laterally extended from the other end portion 13 thereof and inclined relative to the first cutter blade 10 for forming a substantially L-shaped structure and arranged for allowing the cutter blades 10, 30 and the arm 15 of the first cutter blade 10 to form a substantially sector-shaped structure, best shown in FIGS. 3, 4, and includes a wedge-shaped swelling or bulge or an inclined ramp 16 extended from a free end portion 17 of the arm 15 and extended or directed toward the first end portion 12 of the first cutter blade 10.

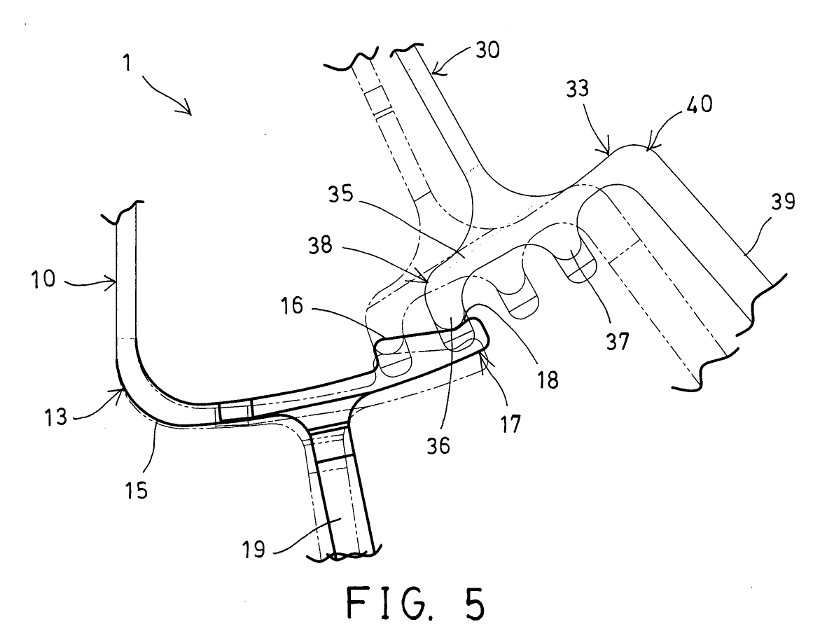

The second cutter blade 30 includes a bar 35 laterally extended from the other end portion 33 thereof and inclined relative to the first cutter blade 10 or substantially perpendicular to the second cutter blade 30 for forming a substantially T-shaped structure, and includes one or more (such as two pairs of) projections 36, 37 extended from the bar 35 and extended away from the one end portion 32 of the second cutter blade 30 for slidably engaging with the ramp 16 of the first cutter blade 10 (FIGS. 3-5) and for adjustably coupling the other end portions 13, 33 of the cutter blades 10, 30 together. It is preferable that the first cutter blade 10 includes a depression or socket 18 formed in the free end portion 17 of the arm 15 for receiving or engaging with the projections 36, 37 of the bar 35 and/or of the second cutter blade 30 and for stably retaining the cutter blades 10, 30 together.

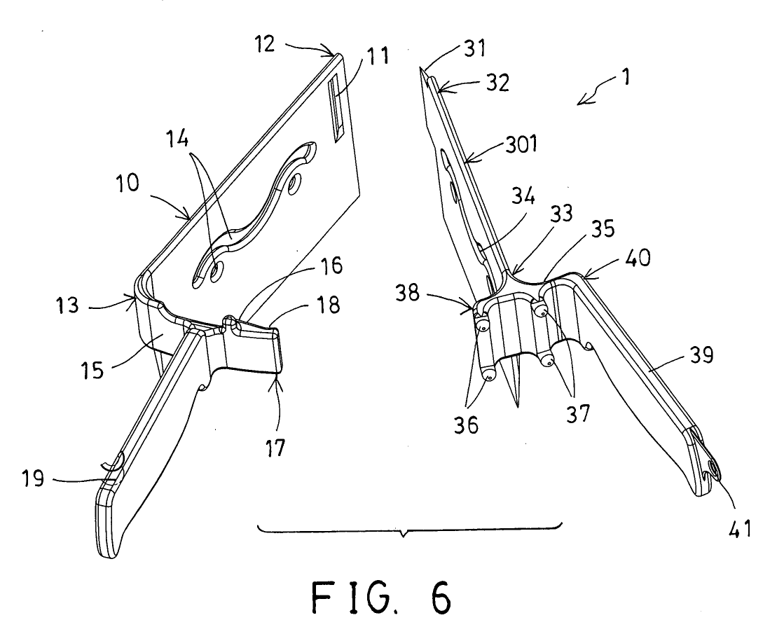

It is preferable that the first projections 36 are extended from one end portion 38 of the bar 35 and extended or directed toward the first cutter blade 10, and the other or second projections 37 are extended from the middle portion of the bar 35, and a handle 39 is extended from the other end portion 40 of the bar 35 for being grasped or held or operated by the users. The first cutter blade 10 also includes a handle 19 extended from such as the middle portion of the arm 15 for being grasped or held or operated by the users, and arranged for allowing the other end portions 13, 33 of the cutter blades 10, 30 to be moved toward or away from each other or to be adjustable relative to each other to different width with the handles 19, 39. As shown in FIG. 6, the second cutter blade 301 may include an ear or other tool element 41 attached to or extended from the handle 39 for such as hanging purposes.

In operation, as shown in FIG. 3, when the first projections 36 of the bar 35 of the second cutter blade 30 are slidably engaged with the ramp 16 of the first cutter blade 10, the other end portions 13, 33 of the cutter blades 10, 30 may be spaced away from each other for a relatively greater distance and for forming a relatively greater sector-shaped structure. Alternatively, as shown in FIG. 4, when the other or second projections 37 of the bar 35 of the second cutter blade 30 are slidably engaged with the ramp 16 of the first cutter blade 10, the other end portions 13, 33 of the cutter blades 10, 30 may be spaced away from each other for a relatively smaller distance and for forming a relatively smaller sector-shaped structure and for cutting the cake into different sizes or dimensions or areas or volumes.

In addition, the projections 36, 37 may also be moved or adjusted along the ramp 16 of the first cutter blade 10 for further adjusting the other end portions 13, 33 of the cutter blades 10, 30 relative to each other. Either of the projections 36, 37 may be selectively engaged or seated in the socket 18 of the arm 15 for stably retaining or maintaining the cutter blades 10, 30 together or in engagement with each other, and for preventing the cutter blades 10, 30 from being separated or disengaged from each other. After cutting operation or use, the projections 36, 37 of the second cutter blade 30 may be easily and quickly detached from the arm 15 of the first cutter blade 10, and the engaging members 11, 31 of the cutter blades 10, 30 may also be easily and quickly detached from each other for allowing the cake cutter 1 to be easily operated by the users.

Accordingly, the cake cutter in accordance with the present invention includes two cutter blades easily and readily and detachably coupled together, and adjustable relative to each other for cutting a piece of cake into any selected or required dimensions or widths.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A cake cutter comprising:
a first cutter blade including a female engaging member provided on a first end portion of said first cutter blade, and
a second cutter blade including a male engaging member provided on a first end portion of said second cutter blade for engaging with said female engaging member of said first cutter blade and for allowing said first end portions of said first and said second cutter blades to be pivotally coupled together and to be quickly detached from each other.

2. The cake cutter as claimed in claim 1, wherein said female engaging member of said first cutter blade is a slot formed in said first end portion of said first cutter blade, and said male engaging member of said second cutter blade is a tongue extended from said first end portion of said second cutter blade.

3. The cake cutter as claimed in claim 1, wherein said first cutter blade includes an arm extended from a second end portion of said first cutter blade, and includes a ramp extended from said arm, and said second cutter blade includes at least one projection extended from a second end portion of said second cutter blade for slidably engaging with said ramp of said first cutter blade and for adjustably coupling said second end portions of said first and said second cutter blades together.

4. The cake cutter as claimed in claim 3, wherein said first cutter blade includes a handle extended from said arm.

5. The cake cutter as claimed in claim 3, wherein said second cutter blade includes a handle extended from said second end portion of said second cutter blade.

6. The cake cutter as claimed in claim 3, wherein said second cutter blade includes a bar extended from said second end portion of said second cutter blade, and said at least one projection is extended from said bar.

7. The cake cutter as claimed in claim 3, wherein said second cutter blade includes a second projection extended from said second end portion of said second cutter blade for selectively and slidably engaging with said ramp of said first cutter blade.

8. A cake cutter comprising:
a first cutter blade including a first end portion and a second end portion, and including an arm extended from said second end portion of said first cutter blade, and including a ramp extended from said arm,
a second cutter blade including a first end portion pivotally coupled to said first end portion of said first cutter blade, and including a second end portion, and including at least one projection extended from said second end portion of said second cutter blade for slidably engaging with said ramp of said first cutter blade and for adjustably coupling said second end portions of said first and said second cutter blades together.

9. The cake cutter as claimed in claim 8, wherein said first cutter blade includes a handle extended from said arm.

10. The cake cutter as claimed in claim 8, wherein said second cutter blade includes a handle extended from said second end portion of said second cutter blade.

11. The cake cutter as claimed in claim 8, wherein said second cutter blade includes a bar extended from said second end portion of said second cutter blade, and said at least one projection is extended from said bar.

12. The cake cutter as claimed in claim 8, wherein said second cutter blade includes a second projection extended from said second end portion of said second cutter blade for selectively and slidably engaging with said ramp of said first cutter blade.

13. The cake cutter as claimed in claim 8, wherein said first cutter blade includes a female engaging member provided on said first end portion of said first cutter blade, and said second cutter blade includes a male engaging member provided on said first end portion of said second cutter blade for engaging with said female engaging member of said first cutter blade and for allowing said first end portions of said first and said second cutter blades to be pivotally coupled together and to be quickly detached from each other.

14. The cake cutter as claimed in claim 13, wherein said female engaging member of said first cutter blade is a slot formed in said first end portion of said first cutter blade, and said male engaging member of said second cutter blade is a tongue extended from said first end portion of said second cutter blade.
